(19) United States
(12) Patent Application Publication
(10) Pub. No.: US 2025/0210257 A1
(43) Pub. Date: Jun. 26, 2025

(54) MULTILAYER ELECTRONIC COMPONENT

(71) Applicant: SAMSUNG ELECTRO-MECHANICS CO., LTD., Suwon-si (KR)

(72) Inventors: Ok Nam Kim, Suwon-si (KR); Taek Jung Lee, Suwon-si (KR); Kwang Youl Lee, Suwon-si (KR); Yoon A Jang, Suwon-si (KR)

(73) Assignee: SAMSUNG ELECTRO-MECHANICS CO., LTD., Suwon-si (KR)

(21) Appl. No.: 18/909,615

(22) Filed: Oct. 8, 2024

(30) Foreign Application Priority Data
Dec. 26, 2023 (KR) 10-2023-0191131

(51) Int. Cl. H01G 4/012; H01G 4/232; H01G 4/30

(52) U.S. Cl. CPC H01G 4/012; H01G 4/30; H01G 4/232

(57) ABSTRACT

A multilayer electronic component includes a body including a dielectric layer and an internal electrode disposed alternately with the dielectric layer in a first direction, the internal electrode exposed to one exposed surface among the third and fourth surfaces opposing each other in a second direction and spaced apart from the fifth and sixth surfaces opposing each other in a third direction, and an external electrode disposed on the exposed surface. When a thickness and a width of a central portion of the internal electrode in the third direction, measured on the exposed surface, are respectively denoted by T1 and W1, and a thickness and a width of the central portion of the internal electrode, measured on a central portion of the body in the second direction, are respectively denoted by T2 and W2, T1>T2 and 0.6≤W2/Wi≤0.9 are satisfied.

### CROSS-REFERENCE TO RELATED APPLICATION(S)

This application claims benefit of priority to Korean Patent Application No. 10-2023-0191131 filed on Dec. 26, 2023 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as smartphones, smartwatches, and wearable devices, and serves to charge or discharge electricity therein or therefrom. Such a multilayer ceramic capacitor may be used as a component of various electronic devices due to having a small size, ensuring high capacitance and being easily mounted.

Recently, MLCCs installed in various electronic products have been required to have a smaller size, and MLCCs may be embedded in a substrate or mounted between an application processor (AP) and a printed circuit board. Accordingly, the market for ultra-small MLCCs having a reduced thickness has been expanding.

However, in an ultra-small MLCC, an internal electrode may also need to have a reduced thickness and width. When the width and thickness of the internal electrode are reduced, contact failure between the internal electrode and an external electrode may easily occur. Accordingly, the MLCC may have reduced capacitance or capacitance dispersion may occur. To resolve such an issue, it may be necessary to design a new structure of the internal electrode.

### SUMMARY

An aspect of the present disclosure provides a multilayer electronic component having excellent electrical properties.

However, the aspects of the present disclosure are not limited to those set forth herein, and will be more easily understood in the course of describing specific example embodiments of the present disclosure.

According to an aspect of the present disclosure, there is provided a multilayer electronic component including a body having first and second surfaces opposing each other in a first direction, third and fourth surfaces connected to the first and second surfaces and opposing each other in a second direction, and fifth and sixth surfaces connected to the first to fourth surfaces and opposing each other in a third direction, the body including a dielectric layer and an internal electrode disposed alternately with the dielectric layer in the first direction, the internal electrode extending to one surface among the third and fourth surfaces, and spaced apart from the fifth and sixth surfaces, and an external electrode disposed on the one surface, and connected to the internal electrode. When a thickness of a central portion of the internal electrode in the first direction and a width of the central portion of the internal electrode in the third direction, measured on the one surface, are respectively denoted by T1 and W1, and a thickness of the central portion of the internal electrode in the first direction and a width of the central portion of the internal electrode in the third direction, measured on a central portion of the body in the second direction, are respectively denoted by T2 and W2, T1>T2 and 0.6≤W2/W1≤0.9 may be satisfied.

According to example embodiments of the present disclosure, a multilayer electronic component may have excellent electrical properties.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a schematic cross-sectional view taken along line III-III′ of FIG. 1;

FIG. 5 is a schematic cross-sectional view taken along line IV-IV′ of FIG. 2;

FIG. 6 is a schematic cross-sectional view taken along line V-V′ of FIG. 2;

FIG. 7 is a diagram illustrating an overlap of FIG. 5 and FIG. 6;

FIGS. 8 and 9 are schematic enlarged views of various examples of region “K1” of FIG. 2; and

FIG. 10 is a schematic plan view of a ceramic green sheet on which an internal electrode pattern is printed to manufacture a multilayer electronic component according to an example embodiment of the present disclosure.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction may be defined as a thickness (T) direction, a second direction may be defined as a length (L) direction, and a third direction may be defined as a width (W) direction.

### MULTILAYER ELECTRONIC COMPONENT

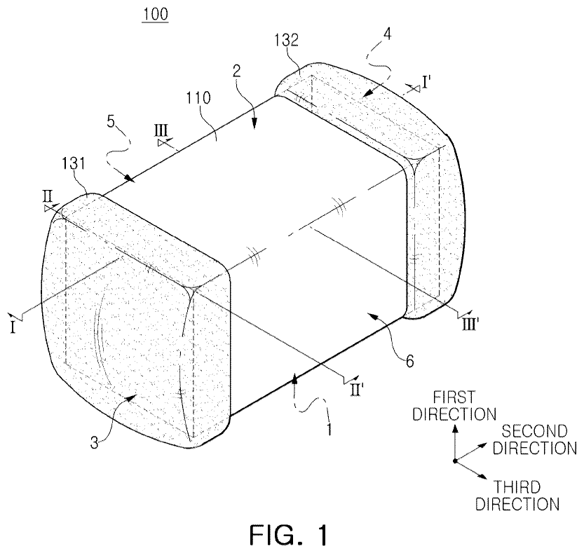

FIG. 1 is a schematic perspective view of a multilayer electronic component according to an example embodiment of the present disclosure.

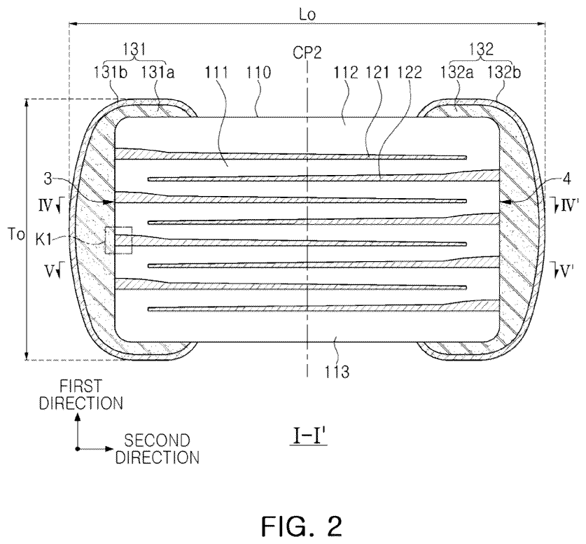

FIG. 2 is a schematic cross-sectional view taken along line I-I′ of FIG. 1.

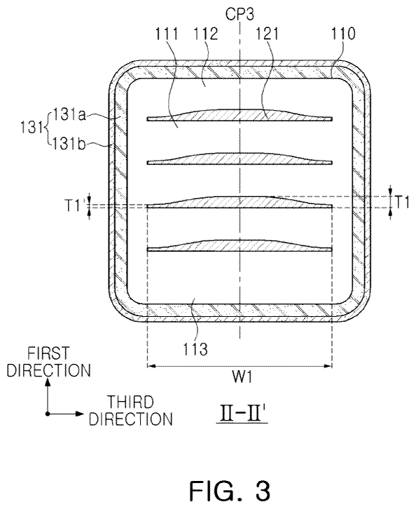

FIG. 3 is a schematic cross-sectional view taken along line II-II′ of FIG. 1.

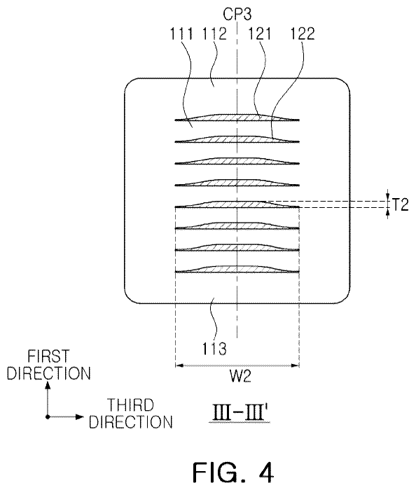

FIG. 4 is a schematic cross-sectional view taken along line III-III′ of FIG. 1.

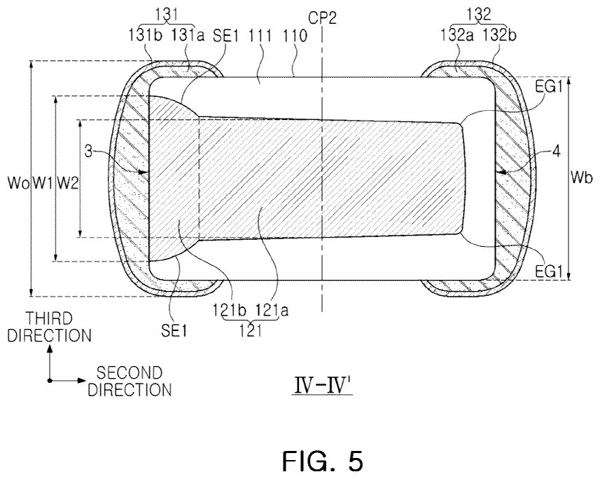

FIG. 5 is a schematic cross-sectional view taken along line IV-IV′ of FIG. 2.

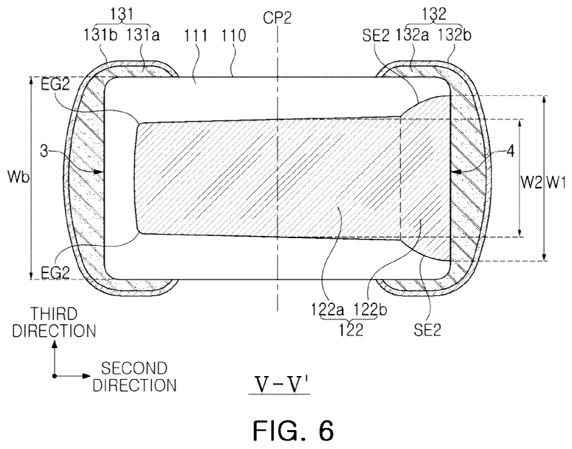

FIG. 6 is a schematic cross-sectional view taken along line V-V′ of FIG. 2.

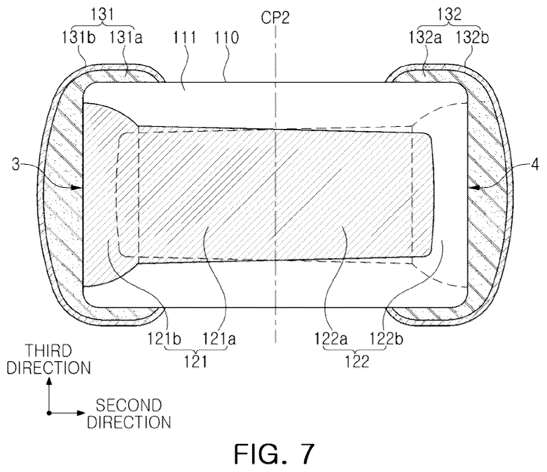

FIG. 7 is a diagram illustrating an overlap of FIG. 5 and FIG. 6.

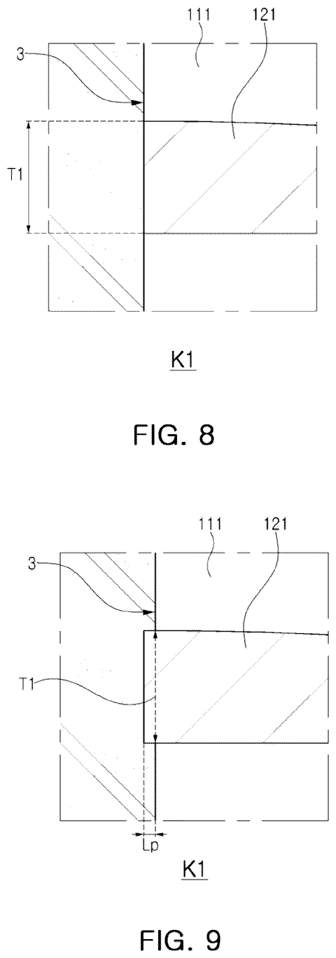

FIGS. 8 and 9 are schematic enlarged views of various examples of region “K1” of FIG. 2.

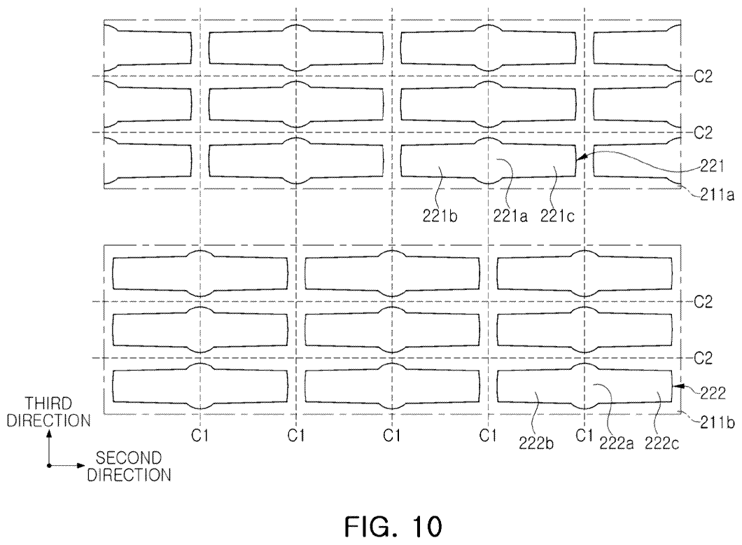

FIG. 10 is a schematic plan view of a ceramic green sheet on which an internal electrode pattern is printed to manufacture a multilayer electronic component according to an example embodiment of the present disclosure.

Hereinafter, a multilayer electronic component 100 according to an example embodiment of the present disclosure will be described in detail with reference to FIGS. 1 to 10. In addition, a multilayer ceramic capacitor (hereinafter referred to as “MLCC”) is described as an example of the multilayer electronic component, but the present disclosure is not limited thereto, and may be applied to various electronic products, such as inductors, piezoelectric elements, varistors, thermistors, or the like.

A size of the multilayer electronic component 100 is not particularly limited. However, as described above, a technical concept of the present disclosure is to improve contact between internal electrodes 121 and 122 and external electrodes 131 and 132 of the ultra-small multilayer electronic component 100, A thickness (To) of the multilayer electronic component 100 in a first direction may be, for example, 150 μm or less, a length (Lo) of the multilayer electronic component 100 in a second direction may be, for example, 250 μm or less, and a width (Wo) of the multilayer electronic component 100 in a third direction may be, for example, 150 μm or less. A lower limit of the thickness (To) of the multilayer electronic component 100 in the first direction is not particularly limited, but may be, for example, 50 μm or more, and a lower limit of the length (Lo) of the multilayer electronic component 100 in the second direction is not particularly limited, but may be, for example, 100 μm or more, and the width (Wo) of the multilayer electronic component 100 in the third direction is not particularly limited, but may be, for example, 50 μm or more.

The multilayer electronic component 100 may include a body 110 including a dielectric layer 111 and internal electrodes 121 and 122, and external electrodes 131 and 132.

A specific shape of the body 110 is not particularly limited. However, as illustrated, the body 110 may have a hexahedral shape or a shape similar thereto. During a sintering process, ceramic powder particles, included in the body 110, may shrink or an edge portion of the body 110 may be polished, such that the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the first to fourth surfaces 1, 2, 3, and 4, the fifth and sixth surfaces 5 and 6 opposing each other in the third direction. A surface roughness of at least one of the first to sixth surfaces 1, 2, 3, 4, 5, and 6 of the body 110 may have an arithmetic average surface roughness (Ra) of 0.2 μm to 1 μm.

The body 110 may include a dielectric layer 111 and internal electrodes 121 and 122 disposed alternately with the dielectric layer 111 in the first direction. A plurality of dielectric layers 111, included in the body 110, may be in a sintered state, and adjacent dielectric layers 111 may be integrated with each other such that boundaries therebetween are not readily apparent without using a scanning electron microscope (SEM).

The dielectric layer 111 may include, for example, a perovskite-type compound, represented by ABO₃, as a main component. The perovskite-type compound, represented by ABO₃, may be, for example, BaTiO₃, (Ba₁₋ₓCaₓ) TiO₃ (0<x<1), Ba(Ti_{1-y}Ca_{y}) O₃ (0<y<1), (Ba₁₋ₓCaₓ) (Ti_{1-y}Zr_{y}) O₃ (0<x<1, 0<y<1), Ba(Ti_{1-y}Zr_{y}) O₃ (0<y<1), CaZrO₃, or (Ca₁₋ₓSrₓ) (Zr_{1-y}Ti_{y}) O₃ (0<x<0.5, 0<y<0.5).

A thickness of the dielectric layer 111 is not particularly limited. For example, an average thickness of the dielectric layer 111, measured in a central portion of the body 110 in the second direction, may be 0.1 μm to 0.6 μm, 0.1 μm to 0.5 μm, or 0.1 μm to 0.4 μm.

Here, the average thickness of the dielectric layer 111 may refer to an average thickness of the dielectric layer 111 in the first direction. The average thickness of the dielectric layer 111, measured in the central portion of the body 110 in the second direction, may be measured by scanning, with an SEM, the central portion of the body 110 in the second direction in a cross-section of the body 110 in the first and second directions, at a magnification of 10,000. More specifically, the average thickness of the dielectric layer 111 may be measured by measuring thicknesses of the dielectric layer 111 at 10 points equally spaced apart from each other in the second direction from the central portion of the body 110. When such average value measurement is performed on ten dielectric layers 111, the average thickness of the dielectric layer 111 may be further generalized.

The internal electrodes 121 and 122 may include, for example, a first internal electrode 121 and a second internal electrode 122 alternately disposed in a first direction with the dielectric layer 111 interposed therebetween. That is, the first internal electrode 121 and the second internal electrode 122, a pair of electrodes having different polarities, may be disposed to oppose each other with the dielectric layer 111 interposed therebetween. The first internal electrode 121 and the second internal electrode 122 may be electrically isolated from each other by the dielectric layer 111 interposed therebetween.

The internal electrodes 121 and 122 may be exposed to one exposed surface, among the third and fourth surfaces 3 and 4, and may be spaced apart from the fifth and sixth surfaces 5 and 6. That is, the first internal electrode 121 may be exposed to the third surface, and may be spaced apart from the fifth and sixth surfaces 5 and 6, and the second internal electrode 122 may be exposed to the fourth surface, and may be spaced apart from the fifth and sixth surfaces 5 and 6. Hereinafter, the third surface 3 through which an end of the first internal electrode 121 is exposed may be defined as a first exposed surface, and a fourth surface 4 through which an end of the second internal electrode 122 is exposed may be defined as a second exposed surface.

The metal, included in the internal electrodes 121 and 122, may be one or more of Ni, Cu, Pd, Ag, Au, Pt, Sn, W, T1, and alloys thereof, and may preferably include Ni, but the present disclosure is not limited thereto.

The body 110 may include a capacitance formation portion disposed in the body 110, the capacitance formation portion including a first internal electrode 121 and a second internal electrode 122, with the dielectric layer 111 interposed therebetween, to form capacitance, and a first cover portion 112 and a second cover portion 113 respectively disposed on one side and the other side of the capacitance formation portion in the first direction. The cover portions 112 and 113 may basically serve to prevent damage to an internal electrode caused by physical or chemical stress. The cover portions 112 and 113 may have a configuration similar to that of the dielectric layer 111, except that an internal electrode is not included.

The external electrodes 131 and 132 may be disposed on the exposed surface and connected to the internal electrodes 121 and 122. For example, the external electrode 131 may include a first external electrode 131 disposed on the third surface 3, the first external electrode 131 extending onto portions of the first surface, the second surface, the fifth surface and the sixth surface 1, 2, 5, and 6, and a second external electrode 132 disposed on the fourth surface 4, the second external electrode 132 extending onto portions of the first surface, the second surface, the fifth surface, and the sixth surface 1, 2, 5, and 6. The first external electrode 131 may be connected to the first internal electrode 121 on the third surface 3, and the second external electrode 132 may be connected to the second internal electrode 122 on the fourth surface 4.

A type or shape of the external electrodes 131 and 132 is not particularly limited, and the external electrodes 131 and 132 may have a multilayer structure. For example, the external electrodes 131 and 132 may include base electrode layers 131a and 132a in contact with the internal electrodes 121 and 122, and plating layers 131b and 132b disposed on the base electrode layers 131a and 132a.

The base electrode layers 131a and 132a may be sintered electrode layers including a metal and glass. The metal, included in the base electrode layers 131a and 132a, may include Cu, Ni, Pd, Pt, Au, Ag, Pb, and/or an alloy including the same, but the present disclosure is not limited thereto. The glass, included in the base electrode layers 131a and 132a, may include one or more oxides of Ba, Ca, Zn, Al, B, and Si, but the present disclosure is not limited thereto.

The basic electrode layers 131a and 132a may be formed of only a sintered electrode layer including a metal and glass, but the present disclosure is not limited thereto, and the base electrode layers 131a and 132a may have a multilayer structure. For example, the base electrode layers 131a and 132a may include a base plating layer in contact with the internal electrodes 121 and 122, and a sintered electrode layer disposed on the base plating layer.

The base plating layer may be disposed only on a portion of the exposed surface, and the sintered electrode layer may extend onto portions of the first surface, the second surface, the fifth surface, and the sixth surface 1, 2, 5, and 6 from the exposed surface. The base plating layer may serve to improve contact between the internal electrodes 121 and 122 and the external electrodes 131 and 32. The base plating layer may be disposed on ends of the internal electrodes 121 and 122, and may be discontinuously disposed on the exposed surface. The base plating layer may include one or more of Ni, Cu, and Pd.

The plating layers 131b and 132b may improve mounting properties. The plating layers 131b and 132b may include, for example, Ni, Sn, Pd, and/or an alloy including the same, and may be formed of a plurality of layers. The plating layers 131b and 132b may be, for example, a Ni plating layer or a Sn plating layer, and a Ni plating layer and an Sn plating layer, sequentially formed. In addition, the plating layers 131b and 132b may include a plurality of Ni plating layers and/or a plurality of Sn plating layers.

In the drawings, a structure is illustrated in which the multilayer electronic component 100 has two external electrodes 131 and 132, but the present disclosure is not limited thereto, and the number or shapes of the external electrodes 131 and 132 may be changed depending on shapes of the internal electrodes 121 and 122 or other purposes.

Referring to FIGS. 3 and 4, when a thickness of a central portion of the internal electrode 121 and 122 in the first direction and a width of the central portion of the internal electrode 121 and 122 in the third direction, measured on the exposed surface, are respectively denoted by T1 and W1, and a thickness of the central portion of the internal electrode 121 and 122 in the first direction and a width of the central portion of the internal electrode 121 and 122 in the third direction, measured on the central portion of the body 110 in the second direction, are respectively denoted by T2 and W2, T1>T2 and W1>W2 may be satisfied.

For example, a thickness of a central portion of the first internal electrode 121 in the first direction, measured on the first exposed surface, may be greater than a thickness of the central portion of the first internal electrode 121 in the first direction, measured on the central portion of the body 110 in the second direction, and a width of the first internal electrode 121 in the third direction, measured on the first exposed surface, may be greater than a width of the first internal electrode 121 in the third direction, measured on the central portion of the body 110 in the second direction.

For example, a thickness of a central portion of the second internal electrode 122 in the first direction, measured on the second exposed surface, may be greater than a thickness of the central portion of the second internal electrode 122 in the first direction, measured on the central portion of the body 110 in the second direction, and a width of the second internal electrode 122 in the third direction, measured on the second exposed surface, may be greater than a width of the second internal electrode 122 in the third direction, measured on the central portion of the body 110 in the second direction.

A thickness of each of the internal electrodes 121 and 122 in the first direction, measured on the exposed surface, may be greater than a thickness of each of the internal electrodes 121 and 122 in the first direction, measured on the central portion of the body 110 in the second direction, and a width of each of the internal electrodes 121 and 122 in the third direction, measured on the exposed surface, may be greater than a width of each of the internal electrodes 121 and 122 in the third direction, measured on the central portion of the body 110 in the second direction, such that a contact area between the internal electrodes 121 and 122 and the external electrodes 131 and 132 may be increased. As a result, the multilayer electronic component 100 may have improved electrical properties, such as suppressing capacitance dispersion of the multilayer electronic component 100.

When an overall thickness of each of the internal electrodes 121 and 122 in the first direction is increased to increase the contact area between the internal electrodes 121 and 122 and the external electrodes 131 and 132, the ultra-small multilayer electronic component 100 may have excessively reduced capacitance. When an overall width of each of the internal electrodes 121 and 122 in the third direction is increased, a crack may occur in the body 110 or the multilayer electronic component 100 may have lowered moisture resistance reliability. Accordingly, it may be preferable to satisfy T1>T2 and W1>W2.

According to an example embodiment of the present disclosure, 0.6≤W2/W1≤0.9 may be satisfied. When W2/W1 satisfies the above condition, reliability of the multilayer electronic component 100 may be ensured while improving contact between the internal electrodes 121 and 122 and the external electrodes 131 and 132.

When W2/W1 is less than 0.6 due to W1 having an excessively large value, the multilayer electronic component 100 may have lowered moisture resistance reliability or a crack may occur in the body 110. When W2/W1 is less than 0.6 due to W2 having an excessively small value, the multilayer electronic component 100 may be reduced capacitance. When W2/W1 is greater than 0.9 due to W1 having an excessively small value, the present disclosure may have an insignificant effect of improving contact between the internal electrodes 121 and 122 and the external electrodes 131 and 132. When W2/W1 is greater than 0.9 due to W2 having an excessively large value, the multilayer electronic component 100 may have lowered moisture resistance reliability or a crack may occur in the body 110.

W1 is not particularly limited. However, when a width of the body 110 in the third direction is denoted by Wb, a ratio (W1/Wb) of W1 to Wb may be 0.2 or more and 0.8 or less. When W1/Wb is less than 0.2, the present disclosure may have an insignificant effect of improving contact between the internal electrodes 121 and 122 and the external electrodes 131 and 132. When W1/Wb is greater than 0.8, the multilayer electronic component 100 may have lowered moisture resistance reliability or a crack may occur in the body 110.

According to an example embodiment of the present disclosure, 0.5≤T2/T1<1 may be satisfied. When T2/T1 satisfies the above condition, reliability of the multilayer electronic component 100 may be ensured while improving contact between the internal electrodes 121 and 122 and the external electrodes 131 and 132.

When T2/T1 is less than 0.5 due to T1 having an excessively large value, delamination may occur in the internal electrodes 121 and 122 are or a crack may occur in the body 110, such that the multilayer electronic component 100 may have lowered moisture resistance reliability. When T2/T1 is less than 0.5 due to T2 having an excessively small value, dielectric breakdown voltage properties may be lowered. An upper limit of T2/T1 is not particularly limited, and T2/T1 may be less than 1.

T1 is not particularly limited, but may be, for example, 0.2 μm or more and 2.0 μm or less.

T1 and the W1 may be measured in an image obtained by polishing the multilayer electronic component 100 up to the exposed surface in the second direction to expose the exposed surface (for example, the cross-section illustrated in FIG. 3), and then observing the exposed surface with an SEM. However, in the present specification, measuring the T1 and the W1 in the exposed surface may mean measuring T1 and the W1 in the vicinity of the exposed surface such that those skilled in the art could understand that T1 and W1 are measured on the exposed surface. Accordingly, considering an error of a polishing process for measurement, T1 and the W1 may not only be accurately measured on the exposed surface, but may also be measured on a cross-section of the body 110 in the first and third directions within a distance of 5 μm in the second direction from the exposed surface. T1 may be measured on a dead center CP3 of the body 110 in the third direction.

T2 and W2 may be measured in an image obtained by polishing the multilayer electronic component 100 up to the central portion of the body 110 in the second direction to expose the central portion of the body 110 in the second direction (for example, the cross-section illustrated in FIG. 4), and then observing the exposed cross-section with an SEM. T2 and W2 may not only be measured on a dead center CP2 of the body 110 in the second direction, but may also be measured in a cross-section of the body 110 in the first and third directions within a distance of 5 μm in the second direction from the dead center CP2 of the body 110 in the second direction, considering an error of a polishing process for measurement. T2 may be measured in the dead center CP3 of the body 110 in the third direction.

When a thickness of a side end of each of the internal electrodes 121 and 122 in the third direction, measured on the exposed surface, is denoted by T1′, T1>T1′ may be satisfied. In an example embodiment, a thickness of each of the internal electrodes 121 and 122, measured on the exposed surface, may gradually decrease from a central portion of each of the internal electrodes 121 and 122 in the third direction toward the side end of each of the internal electrodes 121 and 122 in the third direction. That is, a thickness of the first internal electrode 121, measured on the first exposed surface, may gradually decrease from a central portion of the first internal electrode 121 in the third direction toward a side end of the first internal electrode 121 in the third direction, and a thickness of the second internal electrode 122, measured on the second exposed surface, may gradually decrease from a central portion of the second internal electrode 122 in the third direction toward a side end of the second internal electrode 122 in the third direction.

Here, the thickness of each of the internal electrodes 121 and 122 gradually decreasing from the central portion of each of the internal electrodes 121 and 122 in the third direction toward the side end of each of the internal electrodes 121 and 122 in the third direction may mean an overall thickness of each of the internal electrodes 121 and 122 tending to gradually decrease from the central portion of each of the internal electrodes 121 and 122 in the third direction toward the side end of each of the internal electrodes 121 and 122 in the third direction, even when the thickness of each of the internal electrodes 121 and 122 is constant in some sections, or the thickness of each of the internal electrodes 121 and 122 gradually increases from the central portion of each of the internal electrodes 121 and 122 in the third direction toward the side end of each of the internal electrodes 121 and 122 in the third direction in some sections.

In addition, referring to FIG. 2, the thickness of each of the internal electrodes 121 and 122 may gradually decrease from the exposed surface to the inside of the body 110. That is, the thickness of the first internal electrode 121 may gradually decrease from the first exposed surface to the inside of the body 110, and the thickness of the second internal electrode 122 may gradually decrease from the second exposed surface to the inside of the body 110.

Here, the thickness of each of the internal electrodes 121 and 122 gradually decreasing from the exposed surface to the inside of the body 110 may mean an overall thickness of each of the internal electrodes 121 and 122 tending to gradually decrease from the exposed surface to the inside of the body 110, even when the thickness of each of the internal electrodes 121 and 122 is constant in some sections or the thickness of each of the internal electrodes 121 and 122 gradually increases from the exposed surface to the inside of the body 110 in some sections.

Referring to FIGS. 5 to 7, the internal electrodes 121 and 122 may include main portions 121a and 122a disposed on the central portion of the body 110 in the second direction, and lead portions 121b and 122b extending from the main portions 121a and 122a to the exposed surface.

The first internal electrode 121 may include a first main portion 121a disposed on the central portion of the body 110 in the second direction, and a first lead portion 121b extending from the first main portion 121a to the first exposed surface.

The second internal electrode 122 may include a second main portion 122a disposed on the central portion of the body 110 in the second direction, and a second lead portion 122b extending from the second main portion 122a to the second exposed surface. The first main portion 121a may overlap the second main portion 122a in the first direction, thereby forming capacitance of the multilayer electronic component 100.

A width of each of the lead portions 121b and 122b in the third direction may be greater than that of each of the main portions 121a and 122a in the third direction, and the width of each of the lead portions 121b and 122b in the third direction may gradually increase from each of the main portions 121a and 122a to the exposed surface. A portion of the first main portion 121a may overlap the second lead portion 122b in the first direction, and a portion of the second main portion 122a may overlap the first lead portion 121b in the first direction, but the present disclosure is not limited thereto.

In a cross-section of the body 110 in the second and third directions, side ends SE1 and SE2 of the lead portions in the third direction may have a curvature. In an example embodiment, in the cross-section of the body 110 in the second and third directions, a radius of curvature of each of the side ends SE1 and SE2 of the lead portions in the third direction may be 50 μm to 90 μm. In the cross-section of the body 110 in the second and third directions, side ends of the main portions 121a and 122a in the third direction may be substantially straight, but the present disclosure is not limited thereto. A boundary between the main portions 121a and 122a and the lead portions 121b and 122b may be defined as a point at which a slope of each of side ends of the internal electrodes 121 and 122 in the third direction is discontinuously changed.

In the cross-section of the body 110 in the second and third directions, edges EG1 and EG2 at which ends of the internal electrodes 121 and 122 in the second direction, spaced apart from the exposed surface, meet the side ends of the internal electrodes 121 and 122 in the third direction may have a curvature. Accordingly, the multilayer electronic component 100 may have improved withstand voltage properties. A radius of curvature of each of the edges EG1 and EG2 may be less than a radius of curvature of each of the side ends SE1 and SE2 of the lead portions in the third direction.

In an example embodiment, in the cross-section of the body 110 in the second and third directions, the radius of curvature of each of the edges EG1 and EG2 may be 10 μm to 20 μm. When the radius of curvature of each of the edges EG1 and EG2 is less than 10 μm, current may be concentrated on the edges EG1 and EG2, and thus the multilayer electronic component 100 may have lowered withstand voltage properties. When the radius of curvature of each of the edges EG1 and EG2 is greater than 20 μm, the multilayer electronic component 100 may have reduced capacitance.

Referring to FIGS. 5 to 7, a width of each of the internal electrodes 121 and 122 in the third direction may gradually decrease from the exposed surface to the inside of the body 110. Here, the width of each of the internal electrodes 121 and 122 in the third direction gradually decreasing from the exposed surface to the inside of the body 110 mean an overall width of each of the internal electrodes 121 and 122 in the third direction tending to gradually decrease from the exposed surface to the inside of the body 110, even when the width of each of the internal electrodes 121 and 122 in the third direction is constant in some sections or the width of each of the internal electrodes 121 and 122 in the third direction gradually increases from the exposed surface to the inside of the body 110 in some sections.

Referring to FIG. 9, in an example embodiment, the internal electrodes may protrude from the exposed surface. For example, the first internal electrode 121 may protrude from the first exposed surface. Although not illustrated, the second internal electrode 122 may protrude from the second exposed surface. When the internal electrodes 121 and 122 protrude from the exposed surface, contact between the internal electrodes 121 and 122 and the external electrodes 131 and 132 may be improved. A length (Lp) of the first internal electrode 121 protruding from the first exposed surface is not particularly limited, but may be, for example, 0.1 μm to 1.0 μm. When the length (Lp) of the first internal electrode 121 protruding from the first exposed surface is less than 0.1 μm, the effect of improving contact between the internal electrodes 121 and 122 and the external electrodes 131 and 132 may be insignificant. When the length (Lp) is greater than 1.0 μm, a crack may occur in the body 110 due to an excessive protruding length of each of the internal electrodes 121 and 122.

Hereinafter, an example of a method of forming the multilayer electronic component 100 according to an example embodiment of the present disclosure will be described with reference to FIG. 10.

First, ceramic powder particles for forming ceramic green sheets 211a and 211b may be prepared. The ceramic powder particles may be (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), CaZrO₃, or (Ca₁₋ₓSrₓ) (Zr_{1-y}Ti_{y})O₃ (0<x<0.5, 0<y<0.5) obtained by partially dissolving Ca or Zr in BaTiO₃. Subsequently, the prepared ceramic powder particles may be dried and ground, an organic solvent such as ethanol and a binder such as polyvinyl butyral may be mixed to prepare a ceramic slurry, and then the ceramic slurry may be coated and dried on a carrier film to prepare the ceramic green sheets 211a and 211b.

Subsequently, the internal electrode patterns 221 and 222 may be formed on the ceramic green sheets 211a and 211b by printing a conductive paste for an internal electrode, including metal powder particles, a binder, an organic solvent or the like, to have a predetermined thickness using a screen-printing method, a gravure-printing method, or the like. More specifically, a plurality of first internal electrode patterns 221 may be formed on a first ceramic green sheet 211a, and a plurality of second internal electrode patterns 222 may be formed on a second ceramic green sheet 211b.

A first internal electrode pattern 221 may include a first convex portion 221a, and first and second extension portions 221b and 221c extending from the first convex portion 221a. A thickness of the first convex portion 221a may be greater than a thickness of each of the first and second extension portions 221b and 221c, and a width of the first convex portion 221a in the third direction may be greater than a width of each of the first and second extension portions 221b and 221c in the third direction. In addition, a second internal electrode pattern 222 may include a second convex portion 222a, and third and fourth extension portions 222b and 222c extending from the second convex portion 222a. A thickness of the second convex portion 222a in the first direction may be greater than a thickness of each of the third and fourth extension portions 222b and 222c in the first direction, and a width of the second convex portion 222a in the third direction may be greater than a width of each of the third and fourth extension portions 222b and 222c in the third direction. The convex portions 221a and 222a may form the lead portions 121b and 122b of the internal electrodes 121 and 122 by sintering, and the extension portions 221b, 221c, 222b and 222c may form the main portions 121a and 122a of the internal electrodes 121 and 122 by sintering.

A method of forming the convex portions 221a and 222a is not particularly limited. For example, when the internal electrode patterns 221 and 222 are formed using a gravure-printing method, the convex portions 221a and 222a may be formed by adjusting a size of a pattern cell of a gravure roller or sizes of micro cells included in the pattern cell. For example, when the sizes of micro cells corresponding to the convex portions 221a and 222a are reduced, thicknesses of the convex portions 221a and 222a may be increased.

Thereafter, the ceramic green sheets 211a and 211b on which the internal electrode patterns 221 and 222 are printed may be peeled off from the carrier film. Subsequently, the first ceramic green sheet 211a on which the first internal electrode pattern 221 is formed and the second ceramic green sheet 211b on which the second internal electrode pattern is formed may be alternately laminated to correspond to a predetermined number of layers and then compressed to form a ceramic laminate. A ceramic green sheet on which an internal electrode pattern is not formed may be laminated on upper and lower portions of the ceramic laminate to correspond to a predetermined number of layers to form the cover portions 112 and 113 on which sintering has been performed.

Thereafter, the ceramic laminate may be cut along a plurality of first cutting lines C1 and a plurality of second cutting lines C2 to have a predetermined chip size. The convex portions 221a and 222a may be positioned on the first cutting line C1. Thereafter, when the cut chip is sintered at a temperature, for example, greater than or equal to 1000° C. and less than or equal to 1400° C., the body 110 may be formed.

Thereafter, the base electrode layers 131a and 132a may be formed by dipping the body 110 in a conductive paste including metal powder particles, a glass frit, a binder, and an organic solvent, and sintering the conductive paste at a temperature of 500° C. to 900° C., for example.

When the base electrode layers 131a and 132a include a base plating layer and a sintered electrode layer disposed on the base plating layer, the base electrode layers 131a and 132a may be formed by forming the base plating layer on the body 110 using an electroplating method and/or an electroless plating method, dipping the body 110 on which the base plating layer is formed in the conductive paste, and then sintering the body 110.

Subsequently, the multilayer electronic component 100 may be manufactured by forming the plating layers 131b and 132b using an electroplating method and/or an electroless plating method. However, the above-described manufacturing method may be an example, and the method of manufacturing the multilayer electronic component 100 is not limited to the above-described manufacturing method.

### Experimental Example

Using the above-described method, a sample chip having a size 0201 (Lo: about 2.0 mm, Wo: about 1.0 mm, To: about 1.0 mm) was manufactured. Thereafter, the sample chip was polished such that the exposed surface was externally exposed, and the exposed surface (a cross-section in the first and third directions) was observed with an SEM to measure T1 and W1. T1 was measured in a center of a body of a sample chip in the third direction. Subsequently, the sample chip was polished up to a central portion of the body in the second direction, and then the exposed cross-section (the cross-section in the first and third directions) was observed with an SEM to measure T2 and W2. T2 was measured in the center of the body of the sample chip in the third direction. In Table 1 below, W2 of each sample number was fixed at 50 μm and T2 was fixed at 1.0 μm, and only T1 and W1 were adjusted for each sample number, but T1 was adjusted to be greater than T2.

Thereafter, contact evaluation and crack defect evaluation according to W2/W1 and T2/T1 were performed. Specifically, contact was evaluated using a capacitance meter. On the basis of a target capacitance of 100 pF, contact was determined as good (o) when a capacitance is 90 pF or more, contact was determined as normal (Δ) when the capacitance is 80 pF or more, and contact was determined as defective (×) when the capacitance is less than 80 pF. In addition, in the crack defect evaluation, crack defect was determined as defective (NG) when there was even one sample chip in which a crack occurred, among 100 sample chips, for each test number, and crack defect was determined as good (OK) when there was no sample chip in which a crack occurred, and results of such determination are indicated in Table 1 below.

TABLE 1

| Test Number | W2/W1 | T2/T1 | Contact | Crack Defect |
|---|---|---|---|---|
| 1-1 | 0.95 | 0.9 | × | OK |
| 1-2 | 0.9 | 0.9 | Δ | OK |
| 1-3 | 0.8 | 0.9 | Δ | OK |
| 1-4 | 0.7 | 0.9 | Δ | OK |
| 1-5 | 0.6 | 0.9 | Δ | OK |
| 1-6 | 0.5 | 0.9 | Δ | NG |
| 2-1 | 0.95 | 0.7 | × | OK |
| 2-2 | 0.9 | 0.7 | ∘ | OK |
| 2-3 | 0.8 | 0.7 | ∘ | OK |
| 2-4 | 0.7 | 0.7 | ∘ | OK |
| 2-5 | 0.6 | 0.7 | ∘ | OK |
| 2-6 | 0.5 | 0.7 | ∘ | NG |
| 3-1 | 0.95 | 0.5 | × | OK |
| 3-2 | 0.9 | 0.5 | ∘ | OK |
| 3-3 | 0.8 | 0.5 | ∘ | OK |
| 3-4 | 0.7 | 0.5 | ∘ | OK |
| 3-5 | 0.6 | 0.5 | ∘ | OK |
| 3-6 | 0.5 | 0.5 | ∘ | NG |
| 4-1 | 0.95 | 0.4 | × | NG |
| 4-2 | 0.9 | 0.4 | ∘ | NG |
| 4-3 | 0.8 | 0.4 | ∘ | NG |
| 4-4 | 0.7 | 0.4 | ∘ | NG |
| 4-5 | 0.6 | 0.4 | ∘ | NG |
| 4-6 | 0.5 | 0.4 | ∘ | NG |

Referring to Table 1, in remaining sample numbers excluding sample numbers 1-1, 2-1, 3-1 and 4-1, contact was good or normal. This may be because the sample numbers 1-1, 2-1, 3-1 and 4-1 had W2/W1 of 0.95, and W1 did not have a sufficiently large value compared to W2, and thus contact between the internal and external electrodes was not sufficiently improved.

In sample numbers 1-6, 2-6, 3-6, and 4-6, contact was good or normal, but it may be confirmed that a crack defect occurred. This may be because sample numbers 1-6, 2-6, 3-6, and 4-6 had W2/W1 of 0.5, and W1 had an excessively large value compared to W2, and thus a crack defect occurred.

In sample numbers 4-1 to 4-6, contact was good except for sample number 4-1. However, in all samples, a crack defect occurred. This may be because sample numbers 4-1 to 4-6 had T2/T1 of 0.4, and T1 had an excessively large value compared to T2, and thus a crack defect caused by delamination of an internal electrode occurred.

Conversely, it may be confirmed that the sample numbers 1-2 to 1-5, the sample numbers 2-2 to 2-5, and the sample numbers 3-2 to 3-5 satisfied 0.6≤W2/W1≤0.9 and 0.5≤T2/T1<1, such that contact was fine, and no crack defect occurred.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

As used herein, the term “connected” may not only refer to “directly connected” but also include “indirectly connected” by means of an adhesive layer, or the like. The term “electrically connected” may include both of a case in which components are “physically connected” and a case in which components are “not physically connected.” In addition, the terms “first,” “second,” and the like may be used to distinguish a component from another component, and may not limit a sequence and/or an importance, or others, in relation to the components. In some cases, a first component may be referred to as a second component, and similarly, a second component may be referred to as a first component without departing from the scope of the example embodiments.

What is claimed is:

1. A multilayer electronic component comprising:
a body having first and second surfaces opposing each other in a first direction, third and fourth surfaces connected to the first and second surfaces and opposing each other in a second direction, and fifth and sixth surfaces connected to the first to fourth surfaces and opposing each other in a third direction, the body including a dielectric layer and an internal electrode disposed alternately with the dielectric layer in the first direction, the internal electrode extending to one surface among the third and fourth surfaces; and
an external electrode disposed on the one surface, and connected to the internal electrode,
wherein, when a thickness of a central portion of the internal electrode in the first direction and a width of the central portion of the internal electrode in the third direction, measured on the one surface, are respectively denoted by T1 and W1, and a thickness of the central portion of the internal electrode in the first direction and a width of the central portion of the internal electrode in the third direction, measured on a central portion of the body in the second direction, are respectively denoted by T2 and W2, T1>T2 and 0.6≤W2/W1≤0.9 are satisfied.

2. The multilayer electronic component of claim 1, wherein T1 and T2 satisfy 0.5≤T2/T1<1.

3. The multilayer electronic component of claim 1, wherein
the internal electrode includes a main portion disposed on the central portion of the body in the second direction, and a lead portion extending from the main portion to the one surface, and
a width of the lead portion in the third direction is greater than that of the main portion in the third direction, and the width of the lead portion in the third direction gradually increases from the main portion toward the one surface.

4. The multilayer electronic component of claim 3, wherein, in a cross-section of the body in the second and third directions, a side end of the lead portion in the third direction has a curvature.

5. The multilayer electronic component of claim 4, wherein, in the cross-section of the body in the second and third directions, a radius of curvature of the side end of the lead portion in the third direction is 50 μm to 90 μm.

6. The multilayer electronic component of claim 1, wherein, in a cross-section of the body in the second and third directions, an edge, at which an end of the internal electrode in the second direction, spaced apart from the one surface, meets a side end of the internal electrode in the third direction, has a curvature.

7. The multilayer electronic component of claim 6, wherein, in the cross-section of the body in the second and third directions, a radius of curvature of the edge is 10 μm to 20 μm.

8. The multilayer electronic component of claim 1, wherein, when a thickness of a side end of the internal electrode in the third direction, measured on the one surface, is denoted by T1′, T1>T1′ is satisfied.

9. The multilayer electronic component of claim 1, wherein a thickness of the internal electrode, measured on the one surface, gradually decreases from the central portion of the internal electrode in the first direction toward a side end of the internal electrode in the third direction.

10. The multilayer electronic component of claim 1, wherein a width of the internal electrode in the third direction gradually decreases from the one surface toward the inside of the body.

11. The multilayer electronic component of claim 1, wherein a thickness of the internal electrode gradually decreases from the one surface to the inside of the body.

12. The multilayer electronic component of claim 1, wherein the internal electrode protrudes from the one surface.

13. The multilayer electronic component of claim 1, wherein
a thickness of the multilayer electronic component in the first direction is 150 μm or less,
a length of the multilayer electronic component in the second direction is 250 μm or less, and
a width of the multilayer electronic component in the third direction is 150 μm or less.

14. The multilayer electronic component of claim 1, wherein the internal electrode is spaced apart from the fifth and sixth surfaces.
